(19) United States
(12) Patent Application Publication
(10) Pub. No.: US 2020/0135128 A1
(43) Pub. Date: Apr. 30, 2020

(54) DRIVE TECHNIQUES FOR MODULATION DEVICES

(71) Applicant: Compound Photonics Limited, London (GB)

(72) Inventor: Kevin M. FERGUSON, Beaverton, OR (US)

(73) Assignee: Compound Photonics Limited, London (GB)

(21) Appl. No.: 16/605,684

(22) PCT Filed: May 8, 2018
(86) PCT No.: PCT/US18/31690

§ 371 Date: Oct. 16, 2019

Related U.S. Application Data
(60) Provisional application No. 62/503,301, filed on May 8, 2017.

(51) Int. Cl. G09G 3/36

(52) U.S. Cl. CPC G09G 3/3659; G09G 2320/0285; G09G 3/3666; G09G 3/3696

(57) ABSTRACT

One embodiment provides a driver controller for a light modulation device. The driver controller includes a look-up table (LUT) to store a plurality of binary sequences, each binary sequence corresponding to a target phase response of a pixel of a liquid crystal structure of the light modulation device; wherein at least one binary sequence includes at least one pattern of binary values from among a plurality of patterns of binary values, the patterns of binary values comprising: a first set of patterns, each pattern of the first set of patterns generated as: for n=N−1 . . . 1, n leading “0”s plus a trailing “1”; where n is an index ranging from 1 to N, and N represents a number of target phase responses; and a second set of patterns, each pattern of the second set of patterns generated as: for n=1 to N−2, generate pattern {01x}, where x=n number of trailing “1” s. The driver controller also includes pixel electrode control circuitry to receive data having N target phase responses for at least one pixel and to determine a binary sequence of the LUT that matches a target phase response of the data; the pixel electrode control circuitry also to cause a first voltage level, corresponding to a first binary value of a binary sequence, to be applied to an electrode of the pixel, and to cause a second voltage level, corresponding to a second binary value of a binary sequence, to be applied to the electrode of the pixel.

The present application claims the benefit of U.S. Provisional Application Ser. No. 62/503,301 filed May 8, 2017, which is hereby incorporated by reference in its entirety.

### FIELD

The present disclosure relates to drive techniques for modulation devices, in particular, to digital drive techniques for electromagnetic radiation modulation devices.

### BACKGROUND

Liquid crystal displays are often utilized in devices requiring a small footprint, for example, mini projectors, head mounted displays, and smart glasses. Liquid crystal displays, for example, include pixels elements which are controlled by drive circuitry. The drive circuitry may be analog or digital, and each drive method has its advantages.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a block diagram of a light modulation system according to various embodiments of the present disclosure;

FIG. 2 illustrates a block diagram of look-up table generation logic according to various embodiments of the present disclosure;

FIG. 2A illustrates an example look-up table according to one embodiment of the present disclosure;

FIG. 3 is a flowchart of generating a first look-up table having a plurality of binary sequences according to various embodiments of the present disclosure;

FIG. 4 is a flowchart of testing and look-up table generation operations according to various embodiments of the present disclosure; and

FIG. 5 is a flowchart of digital control operations for a light modulation device according to various embodiments of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure is related to digital pixel control techniques for modulation devices. One example modulation device includes a light modulation device that includes an array of pixels. The digital pixel control techniques disclosed herein include generating a look-up table (LUT) of a plurality of binary sequences. The binary sequences are used to control a pixel, and each binary sequence generates a target phase response of the pixel. Each binary sequence is defined over a sample space length. A sample space is generally defined as a time period for a given operation, for example a frame rate time period, during which a binary sequence is applied to a pixel. Each sequence may therefore translate into a unique duty cycle, meaning the number of “1”s in each sequence is unique (and for example, is representative of the number of times a high digital voltage is applied to a pixel over the sample space. When viewed over the entire sample space, each unique sequence generates a pulse frequency modulation (PFM) control operation of a pixel.

Advantageously, and to reduce ripple errors associated with driving a pixel with digital voltages, each binary sequence is formed of repeating patterns over the sample space, where each pattern may be shorter than the total sample space. The patterns may be generated as follows: 1) for duty cycles of 50% or less, each pattern has a maximum number of “0”s or times no voltage or a low voltage drives a pixel, and 2) for duty cycles greater than 50%, each pattern has a maximum number of “1”s or times a voltage or high voltage drives a pixel, such that the desired mean voltage across a pixel, and thus desired phase response, is achieved. Generating patterns according to these principles, and forming sequences as repeating patterns, generates pixel control voltages that provide, for example, mean stable voltage levels and the lowest ripple error at a given duty cycle.

As stated, each sequence (which is made up of repeating patterns) represents a unique duty cycle. The sequences may be generated so as to generate a first LUT having a range of distributed target duty cycles, for example, linearly distributed target duty cycles from 0% duty cycle to 100% duty cycle. The sequences that correspond to a duty cycle that matches a target duty cycle may be selected for inclusion into the first LUT. There may be some sequences that do not exactly generate a target duty cycle. For those that do not match, duty cycle interpolation techniques are provided herein to select two duty cycles that are over and under a target duty cycle, and generate a new duty cycle that more closely matches the target duty cycle by interpolating the two closest duty cycles. Interpolating the two closest duty cycles generally means to select the pattern from the first duty cycle and the pattern from the second duty cycle and concatenate these patterns over the sample space, thus forming a new sequence having a corresponding duty cycle that matches (or closely matches) the target duty cycle. The first LUT may be updated with the new sequence corresponding to the new duty cycle. This process is repeated until there is a bit sequence for each duty cycle corresponding to a desired phase response.

For some applications, for example, video generation, each pixel of a video frame includes a target phase response level, typically known as bit-depth level (e.g., a 4-bit video frame encodes 2\hat{ }4=16 linearly distributed phase response levels). Once the first LUT is generated that includes the sequences that match or closely match the range of distributed duty cycles, each sequence may be tested for pixel phase response and/or ripple error. If a phase response of a selected sequence matches (or closely matches within a defined tolerance) a target phase response, that sequence may be selected in a final LUT. Since a duty cycle may only roughly correspond to a phase response, a given test sequence may generate phase and/or ripple errors that are out of tolerance. For these cases, duty cycle interpolation techniques are provided herein to select two phase responses (and their corresponding duty cycles) that are over and under a target phase response, and generate a new duty cycle and phase response that more closely matches the target phase response by interpolating the two closest duty cycles. Interpolating the two closest duty cycles generally means to select the pattern from the first duty cycle and the pattern from the second duty cycle and concatenate these patterns over the sample space, thus forming a new sequence having a corresponding duty cycle that matches (or closely matches) the target duty cycle, and thus, the target phase response. The final LUT may be updated with the new sequence corresponding to the new duty cycle.

The final LUT generally includes a number of sequences that equals the number of bit-depth levels. In operation, as input data is parsed to determine a target level for each pixel, a corresponding sequence is selected from the final LUT to drive that pixel with a stable digital voltage over the sample space.

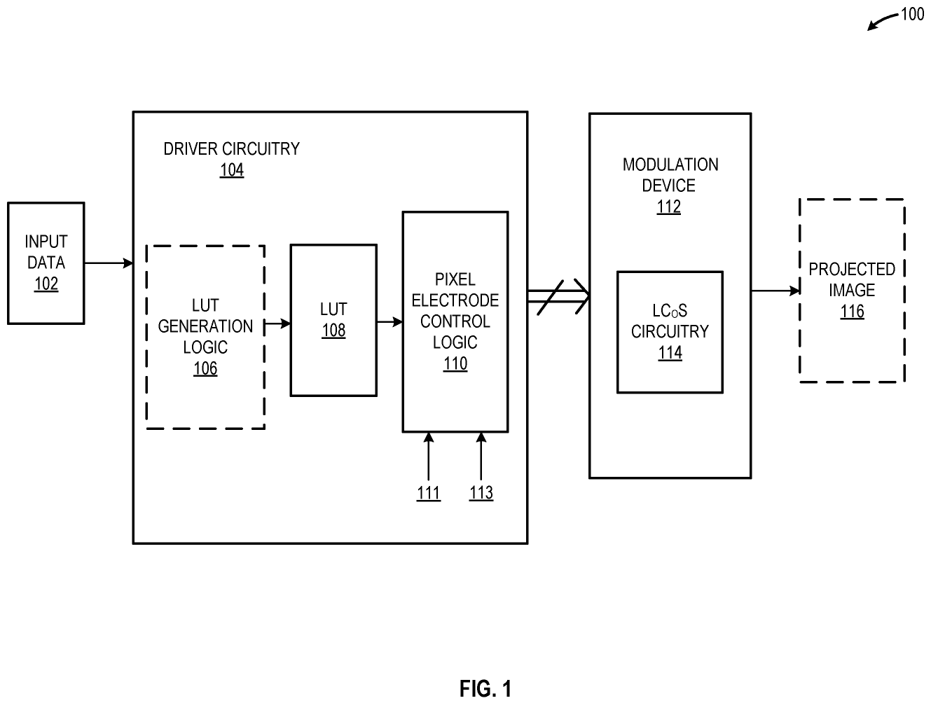

FIG. 1 illustrates a block diagram of an electromagnetic radiation modulation system 100, for example, light modulation system, according to various embodiments of the present disclosure. The system 100 generally includes driver circuitry 104 generally configured to control modulation device 112 to generate, in the case of a projection type display, a projected image 116 based on input data 102 (e.g., image data). The modulation device 112 may include, for example, spatial light modulator (SLM) circuitry. The SLM may include, for example, liquid crystal on silicon (LCoS) display circuitry 114 such as those provided by Compound Photonics. The SLM circuitry (e.g., LCoS circuitry 114) may include phase-type and/or amplitude-type, depending on what is required for a given application. Applications for the electromagnetic radiation modulation system 100 of the present disclosure may generally include, for example, target applications such as holography for heads up displays (HUDs), head-mounted displays (HMDs) for augmented reality (AR) or virtual reality (VR), etc., 3D printing, wavelength selection in high-speed communications, scientific applications (e.g., spectrometry, laser tweezers, femtosecond pulse generation, lens aberration correction, beam steering, interferometry, etc.). Of course, these applications are provided only as examples, not as a limitation of the present disclosure. Although not shown in FIG. 1, as is known, SLM circuitry (e.g., LCoS circuitry 114) may generally include an array (X-Y) of individually addressable (controllable) pixel elements (where each pixel is formed from liquid crystal material or substance) via electrodes formed on a semiconductor material. In an embodiment of the present disclosure, the control of a pixel may include controlling the delay (i.e., the phase of electromagnetic radiation (e.g., light) propagating through a pixel (e.g., transmissive and/or reflective propagation), and thus may control, for example, the nature of the projected image 116. The modulation device 112 may generally be configured to receive electromagnetic radiation (e.g., laser light) and cause a phase shift of the electromagnetic radiation to generate a desired result. The data 102 may include, for example, an image frame having modulation data that includes, for example, phase modulation data, represented by a one or more bits (i.e., bit depth). The bit depth of a given image generally provides a number of modulation states, for example, target phase responses for each pixel of the image data. As described herein, the number of target phase responses corresponds to a number of levels related to the image frame, and may be expressed in binary form, e.g., 4-bit image data has 2\hat{ }4=16 levels.

Conventional driver circuitry for LCoS phase modulation circuitry 114 is generally classified as analog control, where each pixel is controlled with an analog voltage, the magnitude of which controls the phase of a pixel. However, analog control typically requires that the display circuitry (e.g., SLM circuitry) have relatively large pixels (and thus, larger surface area) to accommodate larger pixel electrode space. This is typically required because the control voltage must be held stable over a given time period (e.g., frame rate), and thus integrated capacitors are used to hold control voltages over the required time period. Accordingly, the driver circuitry 104 of the present disclosure is generally configured to drive each individual pixel with digital voltage signals to reduce or eliminate the need for larger pixels, and to reduce or eliminate flicker (phase ripple). The driver circuitry 104 of the present disclosure includes at least one look-up table (LUT) 108 having a plurality of binary sequences (i.e., a sequence of one or more bits), each binary sequence being defined to drive a given pixel at target duty cycle and for a target phase response of the pixel. In some embodiments, a LUT 108 may be generated for each pixel of the SLM device array. In other embodiments, a single LUT 108 may be used for all or some of the pixels of the array. The number of binary sequences of the LUT 108 may be based on the number of levels of the image data 102. The driver circuitry 104 also includes pixel electrode control logic 110 generally configured to address each pixel of the modulation device 112 (e.g., LCoS circuitry 114) with a low digital voltage (e.g., via low voltage rail 113) or a high digital voltage (e.g., via high voltage rail 111) based on a binary sequence from the LUT 108. Of course, it should be understood that the driver circuitry 104 may also include other known and/or proprietary circuitry and/or logic structures, including for example, frame buffer memory/cache, timing circuitry, vertical/horizontal scan line circuitry, processor circuitry, etc.

The driver circuitry 104 may also include and/or utilize LUT generation logic 106 generally configured to generate the plurality of binary sequences of the LUT 108. In some embodiments, the LUT generation logic 106 may be integrated with and/or formed part of the driver circuitry 104. Such an embodiment may enable, for example, calibration and recalibration of the LUT 108 during runtime of the system 100. In other embodiments, the LUT generation logic 106 may be provided as a separate device or set of devices or software (i.e., not integrated with driver circuitry 104). Such an embodiment may reduce the overall size and complexity of the driver circuitry 104. Advantageously, the binary sequences of the LUT 108 of the present disclosure are arranged to reduce mean phase errors (e.g., errors attributed to a mismatch between a target phase response and an actual response) and phase ripple errors, and enable the ability to drive modulation devices having smaller pixel sizes than conventional approaches. The LUT generation logic 106 in connection with the system 100 is described in greater detail below.

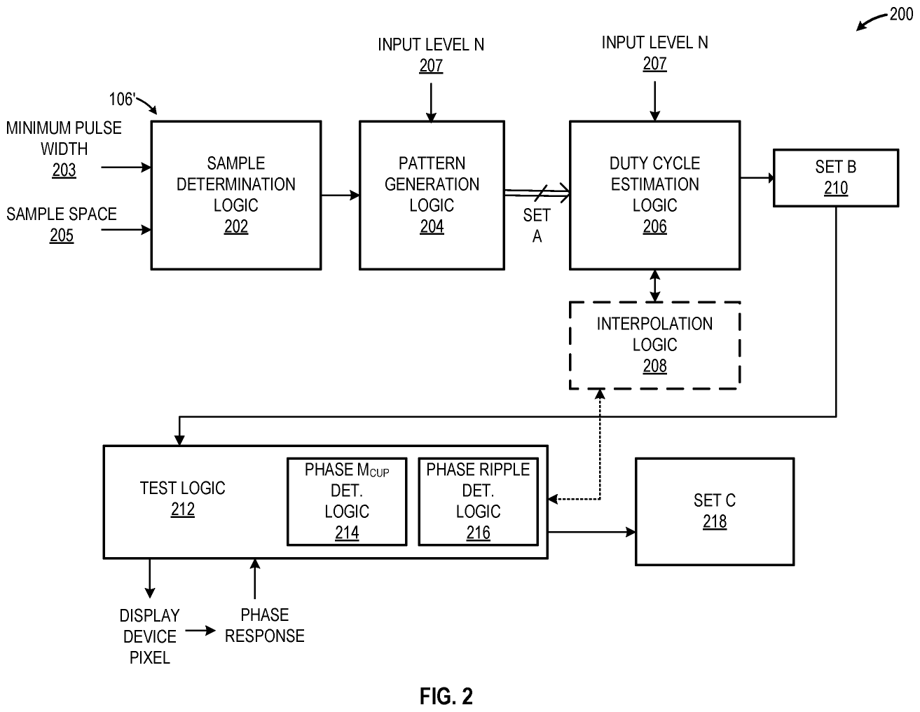

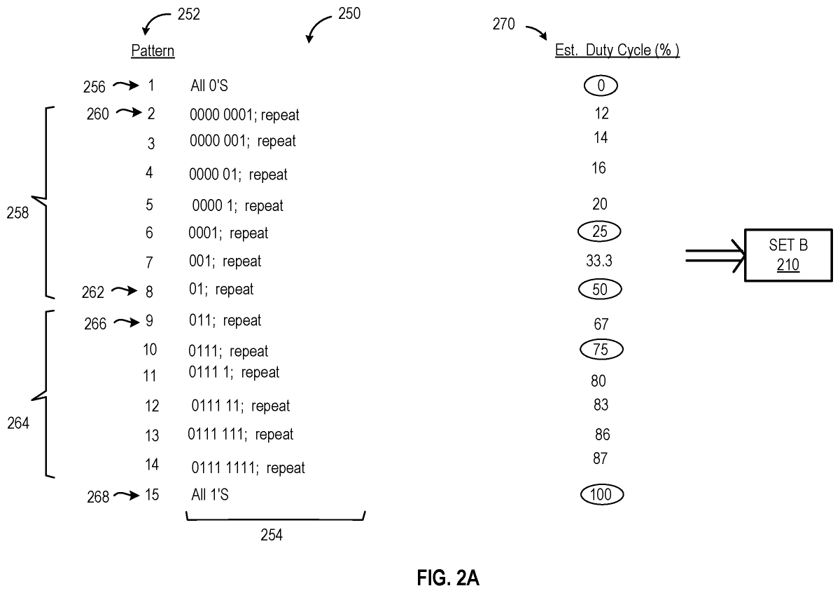

FIG. 2 illustrates a block diagram of the LUT generation logic 106′ according to various embodiments of the present disclosure. As stated above, the LUT generation logic 106′ is generally configured to generate a LUT 108 that may be used for each pixel of the modulation device 112 (e.g., LCoS circuitry 114). The LUT 108 includes a plurality of binary sequences, each sequence corresponding to a target phase response of the liquid crystal associated with a pixel. With continued reference to the system 100 of FIG. 1, the LUT generation logic 106′, in at least one embodiment of the present disclosure, includes sample determination logic 202 generally configured to determine the number of samples (binary values) that may be used during a given time period, based on a minimum pulse width 203 and a sample space time period 205. In this embodiment, the sample determination logic 202 may determine the number of samples over a given sample space as: number of samples=(sample space time period/minimum pulse width). The minimum pulse width 203 may be based on, for example based on the limitations of the pixel electrode control logic 110 (or other circuitry) that generates binary pulses defined by the samples. In other words, the minimum pulse width 203 may be generally set at how fast the pixel electrode control logic 110 is able to generate pulses. In some embodiments, the pulse width may be on the order of 60 μs. The number of samples may be rounded down to the nearest whole number, and any remainder may be ignored. The sample space time period 208 represents the time period associated with a given operation, for example a frame rate time period. As used herein, a “sample” is a binary value, i.e., a logic 1 or a logic 0. A binary “0” in a sequence may cause a low voltage 113 (e.g., reference voltage) to be applied to the electrode of a pixel, while a binary “1” in a sequence may cause a high voltage 111 (e.g., digital ON voltage) to be applied to the electrode of a pixel. In at least one embodiment, the sample times are all equal (i.e., each sample has the same or approximately the same pulse width).

The LUT generation logic 106′ of this embodiment also includes pattern generation logic 204 generally configured to generate a superset of unique binary patterns (referred to herein as “SET A”). A sequence is defined as a unique pattern that is repeated over the sample space. Each sequence corresponds to a unique duty cycle. In some embodiments, pattern generation logic 204 is configured to generate an initial pattern of repeating “0”s over the sample space, representing a 0% duty cycle. In some embodiments, the case of all “0”s in the sample space, representing 0% duty cycle, may be generated by, for example, pixel electrode control logic 110 in response to a O % level (e.g., minimum) of the input data 102.

A first set of patterns may be generated based on the number of levels N 207, generated as:

For N levels, for n=N−1 . . . 1, n leading 0's followed by a single 1. In other words, this first set of patterns have all leading “0” s+a trailing “1” in the final sample spot, where the run length of “0”s are decremented for each subsequent pattern. Each respective pattern may be repeated over the sample space to generate a unique respective sequence.

This process may continue until a 01 pattern is reached. The 01 pattern represents a 50% duty cycle, and the 01 pattern may be repeated over the sample space to define this sequence.

A second set of patterns may also be generated based on the number of levels N 207, generated as:

For n=1 to N−2, 01x where x is n trailing 1's. In other words, the patterns of the second set of patterns may be generated by adding a trailing “1” to each of the previous sequences, and each respective pattern may be repeated over the sample space to generate a unique respective sequence. The last pattern may be generated as repeating “1” over the sample space (representing 100% duty cycle). In some embodiments, the case of all “1”s in the sample space, representing 100% duty cycle, may be generated by, for example, pixel electrode control logic 110 in response to a 100% (e.g., maximum) level of the input data 102.

For the patterns generated as above, in some embodiments, each unique sequence is generated to ensure that each sequence has a unique number of “1”s over the sample space to ensure that each sequence represents a unique duty cycle. Therefore, there may be sequences generated as above that are excluded from SET A as being identical in terms of the number of “1”s over the sample space.

Since the sample space may not permit a pattern to be repeated a whole number of times, the pattern generation logic 204 may be configured to one or more insert blanks (e.g., “0” s) at the end of a repeating pattern to approximately “consume” the entire sample space. In other embodiments, a pattern may be truncated and inserted at the end of a repeating sequence to consume the entire sample space. As an aide in understanding by way of a non-limiting example, FIG. 2A illustrates an example SET A 250 as may be generated by the pattern generation logic 204. Assume for this example that the sample determination logic 202 determines that sample space 254 is 100 samples long, and that there are 8 input levels (N=8). The initial pattern 256 is a pattern having all “0”s over the sample space 254, and this pattern may be excluded from SET A. The first set of patterns 258 include patterns labelled 2-8. The second pattern 260 includes the pattern {0000 0001}, and this pattern may be repeated 12 times over the sample space 254 to define a sequence, with the last 4 bits of this pattern being truncated and added to the end of the last pattern to complete the sample space. This pattern is N samples long, where N=8 in this example. The remaining patterns of the first set of patterns may be generated by removing a leading zero for each subsequent pattern. The eighth pattern 262 represents a 50% duty cycle and includes a repeating {01} pattern over the sample space 254.

The second set of patterns 264 include patterns labelled 9-14. The ninth pattern 266 includes the pattern {011}, and this pattern may be repeated thirty-three times and truncated over the sample space 254. This pattern is 3 samples long, where N=8 in this example. Adding a trailing “1” for each subsequent pattern generates the remaining patterns and thus, the sequences for the second set of patterns 264. The last pattern 268 (pattern 15) is a pattern having all “1”s over the sample space 254. The total number of patterns generated as set forth above is roughly twice the number of input levels N 207. Each unique sequence may be generated by repeating each respective pattern over the sample space (and truncating and/or blanking as necessary).

The inventor herein has determined that generating patterns as defined above for the first and second set of patterns result in respective sequences that have a minimum phase ripple. This is because by maximizing the number of binary “0”s between each binary “1” for duty cycles less than or equal to 50%, and maximizing the number of binary “1”s between each binary “0” for a duty cycle greater than 50%, the resultant sequences have a maximal stability over the sample space, which results in a lowest possible ripple error for a given duty cycle.

Referring again to FIG. 2, once the superset SET A of binary patterns is determined, the LUT generation logic 106′ of this embodiment also includes pattern selection logic 206 generally configured to determine an approximate corresponding duty cycle of each binary pattern in SET A, and match or approximate those binary sequences to a set of linearly distributed duty cycles. The linearly distributed duty cycles may be based on the number of input levels n (207). The number of input levels N may correspond to the bit-depth of the input data 102, e.g., the bit depth of image data. For example, input data 102 may comprise a 3-bit image, meaning that the image data includes 8 levels of linearly distributed phase responses for each pixel (e.g., a phase response that spans from 0-2π in 12.5% phase change increments). A duty cycle may roughly correspond to a phase response, and thus, approximating a corresponding duty cycle of each binary sequence in SET A may enable selection of sequences from SET A that roughly correspond to a linearly distributed phase response.

Referring again to FIG. 2A, column 262 illustrates an estimated duty cycle for each correspond sequence 270. Each duty cycle in column 270 may be generated as:

(the number of l's in a sequence/total number of samples defining the sample space).

Assuming the number of input levels n (207) for this example is 8 levels, a set of linearly distributed target duty cycles is the set 12.5%, 25%, 37.5%, 50%, 62.5%, 75%, 87.5%, 100%). In this example, there are four duty cycles that exactly match a value in this set of linearly distributed target duty cycles, as designated by the circled values in column 270. These four duty cycles correspond to sequences {6, 8, 10}. However, 12.5%, 37.5%, 62.5% and 87.5% do not have an exact match, and thus, a sequence resulting in a duty cycle matching a new interpolated target duty cycle value may be generated, as described below. Referring again to FIG. 2, the LUT generation logic 106′ may also include interpolation logic 208 generally configured to interpolate duty cycles to more closely approximate a target duty cycle. In one embodiment, interpolation logic 208 may be configured to linearly interpolate duty cycles using the two closest matching duty cycles, where the two closest matching duty cycles are selected to be a duty cycle above the target duty cycle and a duty cycle below the target duty cycle. Continuing with the example of FIG. 2A, the closets sequences to the unmatched value of 37.5% are sequence 7 (33%) and sequence 8 (50%). Interpolation logic 208 may interpolate these two sequences by alternating one or more patterns of sequence 7 with one or more patterns of sequence 8 over the sample space.

The sequence comprising the two closest patterns is generated by successively adding one of the two best patterns, measuring the intermediate duty cycle, then adding the appropriate better of the two patterns for adjusting the duty cycle up or down. For constructing the sequence, the first pattern used is the 1^{st} (best matching) pattern.

The intermediate sequence portion has a duty cycle given by:

Intermediate duty cycle=total 1's/total samples in the pattern.

This resulting new intermediate sequence duty cycle is compared with the target duty cycle. If it is lower than the target, then the other pattern is next added to the intermediate sequence to form a new intermediate sequence, and so on until the total sequence is defined. For example, if the target duty cycle is 51%, the first pattern used in the new sequence generated would be 01, which has a duty cycle of 50%. Next a pattern of 011 is used, having a duty cycle of 66%, resulting in an intermediate sequence of 01011, having an intermediate duty cycle of 3/5=60%. Since this is higher than the target 51%, the next pattern added is 01 resulting in an intermediate pattern of 0101101, having a new intermediate duty cycle of 4/7=57.1%. This process is repeated until the sample space is full, resulting in a new sequence with minimum phase ripple and much more accurate mean phase.

The new sequence duty cycle=((u*(total 1's of 1st Pattern)+(v*(total 1's of 2^{nd} Pattern))/(sample space); where u and v are weighting factors indicative of the number of times a pattern is to be repeated to achieve a target duty cycle.

Once sequences that match or approximately match the range of target duty cycles are obtained, the set of sequences may be stored as SET B 210, and each of the sequences of SET B 210 may be tested for phase response and/or ripple error, as described below. As used herein, “approximately”, “approximate”, “closely”, “closest” and other relative terms of this nature may be defined as within a predefined tolerance (e.g., within 5%, within an engineering and/or operational parameter tolerance, etc.) and/or as being relative to some other entity or operational parameter.

Since a duty cycle may only roughly correlate to a phase response of a liquid crystal pixel, LUT generation logic 106′ may also include test logic 212 generally configured to test a phase response of at least one pixel of the modulation device 112 (e.g., LCoS circuitry 114) in response to each sequence of SET B. In addition, test logic 212 may be configured to test other operational parameters such as ripple (e.g., mean ripple, peak-to-peak ripple, etc.) which may negatively impact the performance and phase accuracy of a pixel. To test for phase response of each pixel, the test logic 212 may be configured to include, and/or elicit the aide of, various testing devices such as a sensor, phase detector, oscilloscope, etc., and/or other conventional and/or custom tools and/or devices that may be employed to measure phase response. Test logic 212 may include phase detection logic 214 configured to receive feedback information from a pixel in response to a binary sequence in SET B. The phase response of the pixel may be determined using, for example amplitude modulation response techniques, Bessel 1st order (J1) function diffraction unwrapping techniques, etc., and/or other known and/or custom phase response determination techniques.

Ideally, the phase response for each pixel is linearly distributed over the number of input levels N (207), over a range of phases, for example, 0-2π, etc. For example, for 8 input levels, the phase response would be in 12.5% increments over a phase range. However, as noted above, the duty cycle represented by the binary sequences in SET B may not match a linearly distributed phase response. Therefore, in some embodiments, interpolation logic 208 may be used to interpolate two or more duty cycles for respective binary sequences (and/or patterns thereof), then generate a corresponding new binary sequence to more closely approximate a phase target. As described above, the interpolation logic may interpolate among patterns from SET A, and measure the phase response of each new sequence thus generated.

Generally, interpolation for phase response may be given by:

New target duty cycle=duty cycle of closest match+slope*(target phase−phase of closest match)

where slope=(duty cycle of closest match−duty cycle of second closest match)/(phase of closest match−phase of second closest match). With a new target duty cycle, a sequence corresponding to that duty cycle may be generated, as described above.

In addition to a phase response, the test logic 212 may also include phase ripple detection logic 216 generally configured to measure phase ripple of a pixel in response to a sequence. The phase ripple may be measured as maximum phase ripple, peak-peak phase ripple, mean phase ripple, mean range phase ripple, RMS phase ripple, etc., and generally represents an error that may affect the accuracy and/or operation of the light modulation circuitry 112. Phase ripple may be measured as follows a waveform of 0^{th} (AM) or 1^{st} order (PM) diffraction is captured with a photodiode attached to a digital oscilloscope, a phase unwrap algorithm is applied to convert the diffraction waveform to a phase waveform, peak to peak phase ripple (also sometimes referred to as phase “flicker”) is measured by determining finding the difference between the maximum and minimum phase in the waveform (noise filters or other noise mitigation may be applied as appropriate for the given signal to noise ratio of the captured waveform), and root mean squared (RMS) phase ripple (or “flicker”) is measured as to square root of the mean squared phase waveform deviations from the mean phase.

The phase ripple may be compared to absolute mean phase error (deviation from linear phase profile). In some embodiments, it may be less important to have an accurate phase response and more important to reduce phase ripple. In such embodiments, a sequence constructed of a single binary pattern may be used resulting higher absolute mean phase error in order to minimize phase ripple.

Test logic 212 may continue to test the phase response and/or phase ripple of each binary sequence of SET B for each pixel in the array, or a defined and/or random subset of pixels may be tested. Once each binary sequence of SET B is tested, and updated by interpolation as may be necessary, an updated collection of binary sequences, SET C 218, may be generated. SET C 218 corresponds to LUT 108 of FIG. 1.

The foregoing description of the sequences of SET C 218 is predicated on a linear distribution of duty cycles and phase response. There may be some operational environments that may be able to take advantage of other distribution schemes, for example, exponential distribution, logarithmic distribution, weighted distribution, etc. Accordingly, the LUT generation logic 106′ may also be configured to generate sequences that are not linearly distributed (or approximately linearly distributed), but rather distributed according to another distribution scheme.

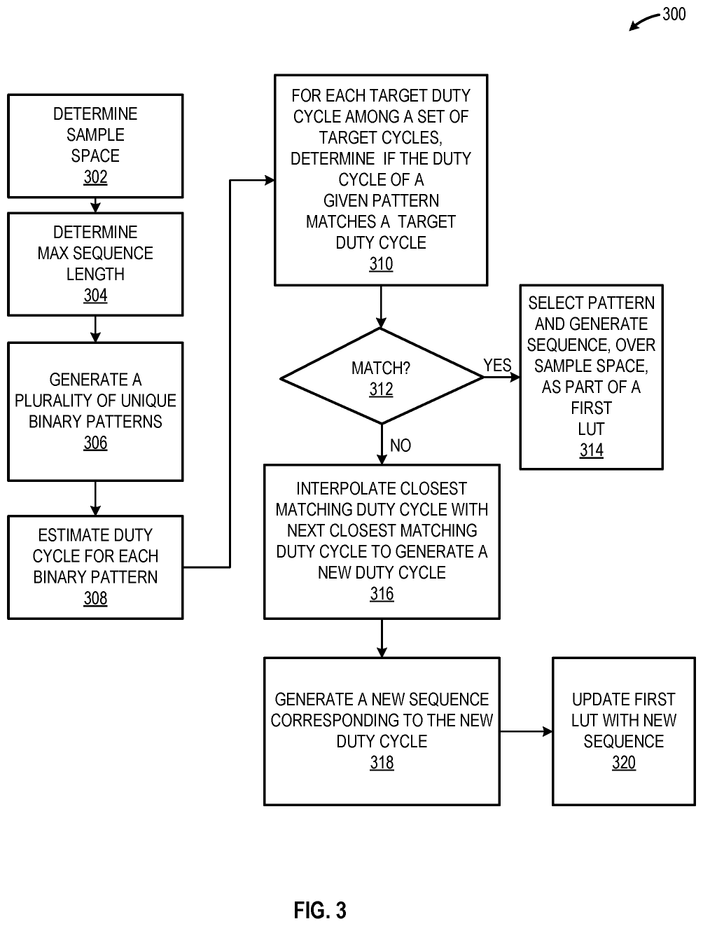

FIG. 3 is a flowchart 300 of generating a first LUT having a plurality of binary sequences according to various embodiments of the present disclosure. In particular, the flowchart 300 illustrates a flowchart of generating a first LUT having a plurality of binary sequences that match and/or approximately match a range of linearly distributed duty cycles. Operations of this embodiment include determining a sample space of a given operational environment 302. In the examples described above, the sample space may include an image or video frame, however, in other embodiments, a sample space may be related to other operational parameters associated with, for example, spectrometry, laser tweezers, femtosecond pulse generation, lens aberration correction, beam steering, interferometry, 3-D imaging such as for medical imaging (MRI replacement), failure analysis, etc. In general, a sample space defines a time period during which a number of binary samples may occur. Typically the control input signal is digital video (or a still image, often rendered as a repeated video frame).

Operations may also include determining a maximum binary sequence length over the sample space 304. Operation 304 may also include determining a minimum pulse width for a binary value of a binary sequence. The minimum pulse width may be based on, for example, the length of the sample space and/or operational parameters and/or limitations of pulse width generation circuitry, etc. Operations of this embodiment may also include generating a plurality of unique binary patterns 306. Operations may also include estimating a duty cycle of each binary pattern 308. The duty cycle of each binary pattern may be estimated as the number of “1”s in a pattern divided by the total number of samples in that pattern. Operations of this embodiment may also, for each target duty cycle among a plurality of target duty cycles, determining if the duty cycle of a given pattern matches a target duty cycle 310. The plurality of target duty cycles may be linearly distributed target duty cycles, and may be defined based on a characteristic of input data, for example the number of phase levels associated with image data. As a general matter, the plurality of linearly distributed target duty cycles may range from 0% to 100%. If a duty cycle of a given pattern matches a target duty cycle 312, the pattern may be selected and a corresponding sequence may be generated from the selected pattern by repeating the pattern over the sample space 314. If a given pattern, as repeated over the sample space, does not consume the entire sample space, the pattern may be truncated and inserted at the end of the last pattern and/or a blank period may be added after the last pattern to complete the sample space. The generated sequence may be added to a first LUT 314. If there are no matches between a pattern and a target duty cycle 312, operations of this embodiment may also include interpolating a closest matching duty cycle with a next-closest match duty cycle over the sample space to generate a new duty cycle 316. If the new duty cycle matches or closely matches target duty cycle, operations may also include generating a sequence corresponding to the new duty cycle 318, and updating the first LUT with the new sequence 318.

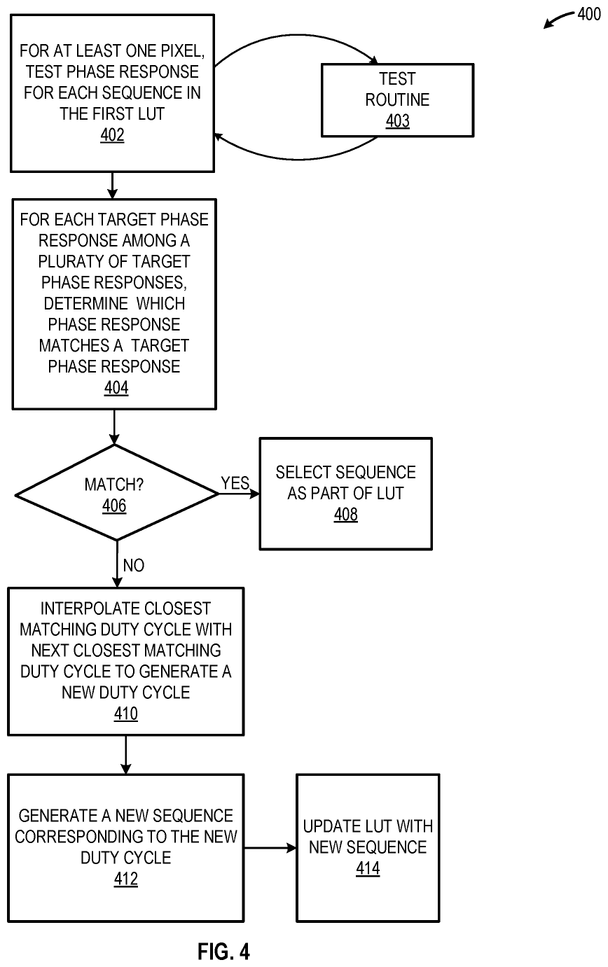

FIG. 4 is a flowchart 400 of testing and LUT generation operations according to various embodiments of the present disclosure. In particular, the flowchart 400 illustrates testing each pixel of an array with the sequences of the first LUT to determine a phase response of each sequence. Operations of this embodiment may include, for each pixel, testing the actual phase response and/or phase ripple of each sequence in the first LUT 402. Testing operations may include invoking one or more test routines 403. Operations may also include, for each target phase response among a plurality of target phase response, determining if there is a match (or an approximate match) between a target phase response and an actual phase response 404. If there is a match 406, the sequence that generated the matching phase response is selected as part of a LUT 408. If an actual phase response does not match a target phase response 406, operations of this embodiment may also include interpolating a closest matching duty cycle with a next-closest match duty cycle over the sample space to generate a new duty cycle 410, and generating a new sequence corresponding to the new duty cycle 412. The new sequence may be tested (at 402) and, if matched to a target phase response, the LUT may be updated with the new sequence 414. The LUT may include N sequences, where N is the number of levels associated with input data.

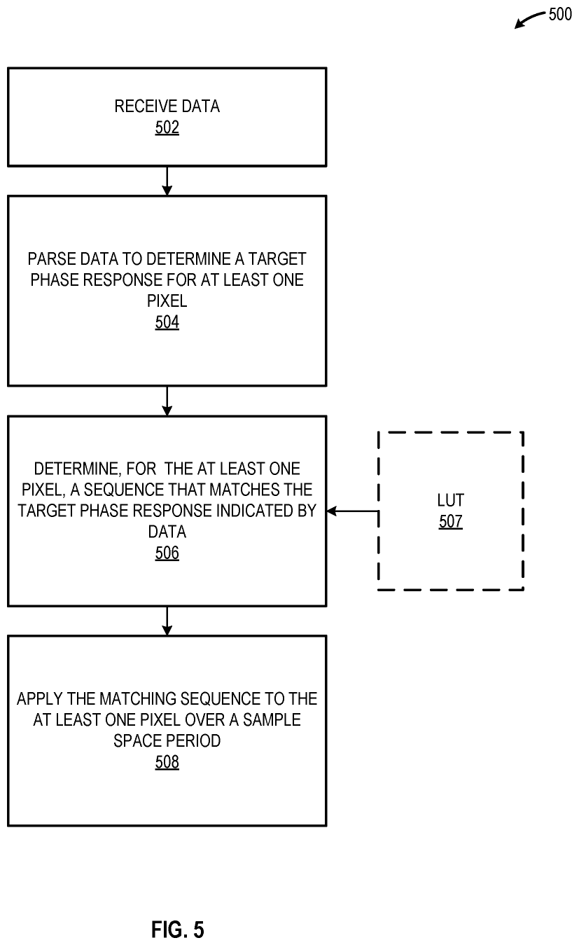

FIG. 5 is a flowchart 500 of digital control operations for a light modulation device. In particular, the flowchart 500 illustrates controlling a light modulation device using a binary sequence. Operations of this embodiment include receiving input data 502, and parsing the input data to determine a target phase response of at least one pixel of a light modulation device 504. Operations may also include determining, for the at least one pixel, a binary sequence that matches the target phase response indicated by the input data 506. In embodiments described herein, the binary sequence may be stored in a look-up table LUT 507. Operations may also include applying the matching sequence to the at least one pixel over a sample space time period 508.

While the flowchart of FIGS. 3, 4 and 5 illustrate operations according various embodiments, it is to be understood that not all of the operations depicted in FIGS. 3, 4 and 5 are necessary for other embodiments. In addition, it is fully contemplated herein that in other embodiments of the present disclosure, the operations depicted in FIGS. 3, 4 and/or 5 and/or other operations described herein may be combined in a manner not specifically shown in any of the drawings, and such embodiments may include less or more operations than are illustrated in FIGS. 3, 4 and 5. Thus, claims directed to features and/or operations that are not exactly shown in one drawing are deemed within the scope and content of the present disclosure.

Accordingly, the present disclosure provides digital control techniques that minimize phase ripple without having to increase pixel size. The binary sequences as described herein are optimized to minimize phase ripple by maximizing the number of binary “0”s between each binary “1” for duty cycles less than or equal to 50%, and maximizing the number of binary “1”s between each binary “0” for a duty cycle greater than 50% maximizing the number of “0” between each “1” instance. In addition, interpolation techniques described herein may advantageously generate binary sequences that more closely match a target phase response and/or reduce phase ripple.

Embodiments of the techniques disclosed herein may be implemented in hardware, software, firmware, or a combination of such implementation approaches. Embodiments of the disclosure may be implemented as computer programs or program code executing on programmable systems comprising at least one processor, a storage system (including volatile and non-volatile memory and/or storage elements), at least one input device, and at least one output device.

As used in any embodiment herein, the term “logic” may refer to an application, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip, system-on-chip (SoC), etc. In some embodiments, the circuitry may be formed, at least in part, by at least one processor executing code and/or instructions sets (e.g., software, firmware, etc.) corresponding to the functionality described herein, thus transforming a general-purpose processor into a specific-purpose processing environment to perform one or more of the operations described herein. In some embodiments, the various components and circuitry of the driver control circuitry 104 and/or light modulation device 112 and/or other systems may be combined in a system-on-a-chip (SoC) architecture.

Embodiments of the operations described herein may be implemented in a computer-readable storage device having stored thereon instructions that when executed by one or more processors perform, at least in part, the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A driver controller for a light modulation device,
a look-up table (LUT) to store a plurality of binary sequences, each binary sequence corresponding to a target phase response of a pixel of a liquid crystal structure of the light modulation device;
wherein at least one binary sequence includes at least one pattern of binary values from among a plurality of patterns of binary values, the patterns of binary values comprising:
a first set of patterns, each pattern of the first set of patterns generated as:
for n=N−1 . . . 1, n leading “0”s plus a trailing “1”; where n is an index ranging from 1 to N, and N represents a number of target phase responses; and
a second set of patterns, each pattern of the second set of patterns generated as:
for n=1 to N−2, generate pattern {01x}, where x=n number of trailing “1” s; and
pixel electrode control circuitry to receive data having N target phase responses for at least one pixel and to determine a binary sequence of the LUT that matches a target phase response of the data; the pixel electrode control circuitry also to cause a first voltage level, corresponding to a first binary value of a binary sequence, to be applied to an electrode of the pixel, and to cause a second voltage level, corresponding to a second binary value of a binary sequence, to be applied to the electrode of the pixel.

2. The driver controller of claim 1, wherein the at least one binary sequence is represented as a repeating at least one pattern, from among the plurality of patterns, over a sample space; wherein the sample space defines the maximum number of samples that are used for each sequence.

3. The driver controller of claim 1, wherein the patterns of binary values also include a pattern of repeating “0”s over a sample space and pattern of repeating “1”s over a sample space; wherein the sample space defines the maximum number of samples that are used for each sequence.

4. The driver controller of claim 1, wherein each binary sequence of the LUT corresponds to a duty cycle, and wherein the LUT comprises a range of binary sequences representing a range of approximately linearly distributed duty cycles.

5. The driver controller of claim 4, wherein at least one sequence having binary values that have a maximum number of binary “0”s between each binary “1” for a duty cycle less than or equal to 50%.

6. The driver controller of claim 4, wherein at least one sequence having binary values that have a maximum number of binary “1”s between each binary “0” for a duty cycle greater than 50%.

7. The driver controller of claim 4, wherein at least one binary sequence generated by an interpolation of a first and second duty cycles, and the at least one binary sequence being formed by alternating a first pattern associated with the first duty cycle and a second pattern associated with the second duty cycle over a sample space to generate an approximately linearly distributed duty cycle; wherein the sample space defines the maximum number of samples that are used for each sequence.

8. The driver controller of claim 1, wherein each of the patterns form a unique sequence, and each sequence representing a unique duty cycle and phase response, and wherein each sequence being tested to generate an actual phase response for each sequence and compared to a target phase response, wherein at least one binary sequence generated by an interpolation of a first and second duty cycles corresponding to a first and second phase responses that are closest to the target phase response, and the at least one binary sequence being formed by alternating a first pattern associated with the first duty cycle and a second pattern associated with the second duty cycle over a sample space to generate sequence that approximately generates the target phase response.

9. The driver controller of claim 1, wherein the plurality of binary sequences representing a range of approximately linearly distributed phase responses.

10. The driver controller of claim 1, wherein the data comprises image data and the target phase response represents a bit depth level of the image data.

11. A method for generating a table of binary sequences to control a pixel of a light modulation device, comprising:
generating a first set of patterns, each pattern of the first set of patterns generated as:
for n=N−1 . . . 1, n leading “0”s plus a trailing “1”; where n is an index ranging from 1 to N, and N represents a number of target phase responses; and
generating a second set of patterns, each pattern of the second set of patterns generated as:
for n=1 to N−2, generate pattern {01x}, where x=n number of trailing “1” s; and
determining, from among the first set of patterns and the second set of patterns, a pattern that matches a linearly distributed duty cycle and repeating that sample over a sample space being defined as the maximum number of samples that are used for each sequence; and
determining, from among the first set of patterns and the second set of patterns, a first pattern that is a closest match to a linearly distributed duty cycle and a second pattern that is a second closest match to the a linearly distributed duty cycle, and interpolating the first duty cycle and the second duty cycle and repeating the first and second pattern over the sample space.

12. The method of claim 11, wherein the patterns of binary values also include a pattern of repeating “0”s over the sample space and pattern of repeating “1”s over a sample space.

13. The method of claim 11, wherein each binary sequence of the LUT corresponds to a duty cycle, and wherein the LUT comprises a range of binary sequences representing a range of approximately linearly distributed duty cycles.

14. The method of claim 13, wherein at least one sequence having binary values that have a maximum number of binary “0”s between each binary “1” for a duty cycle less than or equal to 50%.

15. The method of claim 13, wherein at least one sequence having binary values that have a maximum number of binary “1”s between each binary “0” for a duty cycle greater than 50%.

16. The method of claim 11, wherein each of the patterns form a unique sequence, and each sequence representing a unique duty cycle and phase response, and wherein each sequence being tested to generate an actual phase response for each sequence and compared to a target phase response, wherein at least one binary sequence generated by an interpolation of a first and second duty cycles corresponding to a first and second phase responses that are closest to the target phase response, and the at least one binary sequence being formed by alternating a first pattern associated with the first duty cycle and a second pattern associated with the second duty cycle over a sample space to generate sequence that approximately generates the target phase response.

17. The method of claim 11, wherein the plurality of binary sequences representing a range of approximately linearly distributed phase responses.

18. A light modulation system comprising:
a light modulation device having an array of liquid crystal pixels, each pixel being individually controllable; and
a driver controller to control the light modulation device, the driver controller comprising:
a look-up table (LUT) to store a plurality of binary sequences, each binary sequence corresponding to a target phase response of a pixel of the light modulation device;
wherein at least one binary sequence includes at least one pattern of binary values from among a plurality of patterns of binary values, the patterns of binary values comprising:
a first set of patterns, each pattern of the first set of patterns generated as:
for n=N−1 . . . 1, n leading “0”s plus a trailing “1”; where n is an index ranging from 1 to N, and N represents a number of target phase responses; and
a second set of patterns, each pattern of the second set of patterns generated as:
for n=1 to N−2, generate pattern {01x}, where x=n number of trailing “1” s; and
pixel electrode control circuitry to receive data having N target phase responses for at least one pixel and to determine a binary sequence of the LUT that matches a target phase response of the data; the pixel electrode control circuitry also to cause a first voltage level, corresponding to a first binary value of a binary sequence, to be applied to an electrode of the pixel, and to cause a second voltage level, corresponding to a second binary value of a binary sequence, to be applied to the electrode of the pixel.

19. The system of claim 18, wherein the at least one binary sequence is represented as a repeating at least one pattern, from among the plurality of patterns, over a sample space; wherein the sample space defines the maximum number of samples that are used for each sequence.

20. The system of claim 18, wherein the patterns of binary values also include a pattern of repeating “0”s over a sample space and pattern of repeating “1”s over a sample space; wherein the sample space defines the maximum number of samples that are used for each sequence.

21. The system of claim 18, wherein each binary sequence of the LUT corresponds to a duty cycle, and wherein the LUT comprises a range of binary sequences representing a range of approximately linearly distributed duty cycles.

22. The system of claim 21, wherein at least one sequence having binary values that have a maximum number of binary “0”s between each binary “1” for a duty cycle less than or equal to 50%.

23. The system of claim 21, wherein at least one sequence having binary values that have a maximum number of binary “1”s between each binary “0” for a duty cycle greater than 50%.

24. The system of claim 21, wherein at least one binary sequence generated by an interpolation of a first and second duty cycles, and the at least one binary sequence being formed by alternating a first pattern associated with the first duty cycle and a second pattern associated with the second duty cycle over a sample space to generate an approximately linearly distributed duty cycle; wherein the sample space defines the maximum number of samples that are used for each sequence.

25. The system of claim 18, wherein each of the patterns form a unique sequence, and each sequence representing a unique duty cycle and phase response, and wherein each sequence being tested to generate an actual phase response for each sequence and compared to a target phase response, wherein at least one binary sequence generated by an interpolation of a first and second duty cycles corresponding to a first and second phase responses that are closest to the target phase response, and the at least one binary sequence being formed by alternating a first pattern associated with the first duty cycle and a second pattern associated with the second duty cycle over a sample space to generate sequence that approximately generates the target phase response.

26. The system of claim 18, wherein the plurality of binary sequences representing a range of approximately linearly distributed phase responses.

27. The system of claim 18, wherein the data comprises image data and the target phase response represents a bit depth level of the image data.

28. The system of claim 18, wherein the light modulation device comprises spatial light modulation (SLM) circuitry.

29. The system of claim 18, wherein the light modulation device comprises liquid crystal on silicon (LCoS) circuitry.

30. A non-transitory machine-readable storage medium having stored thereon instructions that, when executed by one or more processors, cause the one or more processors to:
generate a first set of patterns, each pattern of the first set of patterns generated as:
for n=N−1 . . . 1, n leading “0”s plus a trailing “1”; where n is an index ranging from 1 to N, and N represents a number of target phase responses; and
generate a second set of patterns, each pattern of the second set of patterns generated as:
for n=1 to N−2, generate pattern {01x}, where x=n number of trailing “1” s; and
determine, from among the first set of patterns and the second set of patterns, a pattern that matches a linearly distributed duty cycle and repeating that sample over a sample space being defined as the maximum number of samples that are used for each sequence; and
determine, from among the first set of patterns and the second set of patterns, a first pattern that is a closest match to a linearly distributed duty cycle and a second pattern that is a second closest match to the a linearly distributed duty cycle, and interpolating the first duty cycle and the second duty cycle and repeating the first and second pattern over the sample space.

31. The non-transitory machine-readable storage medium of claim 30, wherein the patterns of binary values also include a pattern of repeating “0”s over the sample space and pattern of repeating “1”s over a sample space.

32. The non-transitory machine-readable storage medium of claim 30, wherein each binary sequence of the LUT corresponds to a duty cycle, and wherein the LUT comprises a range of binary sequences representing a range of approximately linearly distributed duty cycles.

33. The non-transitory machine-readable storage medium of claim 32, wherein at least one sequence having binary values that have a maximum number of binary “0”s between each binary “1” for a duty cycle less than or equal to 50%.

34. The non-transitory machine-readable storage medium of claim 32, wherein at least one sequence having binary values that have a maximum number of binary “1”s between each binary “0” for a duty cycle greater than 50%.

35. The non-transitory machine-readable storage medium of claim 30, wherein each of the patterns form a unique sequence, and each sequence representing a unique duty cycle and phase response, and wherein each sequence being tested to generate an actual phase response for each sequence and compared to a target phase response, wherein at least one binary sequence generated by an interpolation of a first and second duty cycles corresponding to a first and second phase responses that are closest to the target phase response, and the at least one binary sequence being formed by alternating a first pattern associated with the first duty cycle and a second pattern associated with the second duty cycle over a sample space to generate sequence that approximately generates the target phase response.

36. The non-transitory machine-readable storage medium of claim 30, wherein the plurality of binary sequences representing a range of approximately linearly distributed phase responses.

37. A method of generating a look-up table of sequences to drive a pixel of display circuitry, comprising:
generate a plurality of binary sequences, each sequence having a plurality of binary values arranged over a sample space, and each sequence corresponding to a duty cycles;
measure a phase response and/or ripple error of each sequence by applying each sequence to the pixel over the sample space;
determining if a phase response of a given sequence is within a defined tolerance of a target phase response; and
determining if a phase response of a given sequence is outside the defined tolerance and interpolating two duty cycles that are closets to the target phase response to generate a sequence that generates a phase response that is within the defined tolerance of the target phase response.

38. The method of claim 37, wherein at least one sequence comprises a pattern that includes a binary pattern having a maximum number of “0” s; wherein the pattern is repeated over the sample space.

39. The method of claim 37, wherein at least one sequence comprises a pattern that includes a binary pattern having a maximum number of “1” s; wherein the pattern is repeated over the sample space.

40. The method of claim 37, further comprising:
determining if each sequence matches a range of distributed target duty cycles; and
determining first pattern that is a closest match to a distributed target duty cycle and a second pattern that is a second closest match to the distributed target duty cycle, and interpolating the first duty cycle and the second duty cycle and repeating the first and second pattern over the sample space.

41. The method of claim 37, wherein the patterns of binary values also include a pattern of repeating “0”s over the sample space and pattern of repeating “1”s over a sample space.

42. The method of claim 37, wherein each binary sequence of the LUT corresponds to a duty cycle, and wherein the LUT comprises a range of binary sequences representing a range of approximately linearly distributed duty cycles.

43. The method of claim 37, wherein at least one sequence having binary values that have a maximum number of binary “0”s between each binary “1” for a duty cycle less than or equal to 50%.

44. The method of claim 37, wherein at least one sequence having binary values that have a maximum number of binary “1”s between each binary “0” for a duty cycle greater than 50%.

45. A method of generating a look-up table of sequences to drive at least one pixel of display circuitry, comprising:
generating a plurality of binary sequences, each sequence having a plurality of binary values arranged for a period of drive time, and wherein each of the plurality of binary sequences has a corresponding duty cycle and a target phase response;
applying each of the plurality of binary sequences to the at least one pixel over the period of drive time;
measuring a phase response from the at least one pixel after application of each of the plurality of binary sequences to the at least one pixel and generating phase response data;
identifying, for each of the plurality of binary sequences, a first measured phase response that is closest to an amount of the target phase response associated with each of the generated plurality of sequences and a second measured phase response that is second closest to the amount of target phase response associated with each of the generated plurality of sequences, and generating at least two identified phase responses; and
generating an interpolated binary sequence based on the phase response data and the target phase response.

46. The method of claim 45, wherein each of the measured phase responses is associated with the duty cycle associated with the binary sequence that generated the measured phase response, and wherein the step of generating an interpolated binary sequence comprises:
calculating a duty cycle difference between duty cycle amounts associated with each of the at least two identified phase responses;
calculating a phase response difference between phase amounts of the first measured phase response and the second measured phase response; and
generating slope data based on the duty cycle difference and the phase response difference.

47. The method of claim 46, wherein the interpolated binary sequence is derived from an interpolated duty cycle, and wherein the step of interpolating the duty cycle comprises:
identifying the duty cycle associated with the first measured phase response;
calculating a difference between the target phase response and the first measured phase response and generating new target phase response data;
multiplying the slope data with the new target response data and generated a factored phase response data; and
adding the factored phase response data to the identified duty cycle associated with the first measured phase response.
